(19) United States
(12) Patent Application Publication
(10) Pub. No.: US 2026/0152371 A1
(43) Pub. Date: Jun. 4, 2026

(54) CRANE HAVING A CRANE BOOM PROVIDED WITH A TAGLINE SYSTEM

(71) Applicant: Itrec B.V., SCHIEDAM (NL)

(72) Inventor: Hendrikus Jacobus WETERINGS, SCHIEDAM (NL)

(73) Assignee: Itrec B.V., SCHIEDAM (NL)

(21) Appl. No.: 19/122,633

(22) PCT Filed: Oct. 17, 2023
(86) PCT No.: PCT/EP2023/078844

§ 371 Date: Apr. 18, 2025

(30) Foreign Application Priority Data
Oct. 19, 2022 (NL) 2033359
Apr. 19, 2023 (NL) 2034632

(51) Int. Cl. B66C 23/18; B66C 13/08; B66C 23/52; B66C 23/82; B66C 23/84

(52) U.S. Cl. CPC B66C 23/185; B66C 13/08; B66C 23/52; B66C 23/82; B66C 23/84

(57) ABSTRACT

A crane with a tagline system, for example for use in the handling of one or more wind turbine components, e.g. handling of a rotor blade. The crane comprises a boom with a boom leg embodied as a latticed hollow box structure. At least one of the front main chords of the boom leg is formed from four steel planar plate members that are welded to one another in a rectangular or square cross-sectional arrangement. The front plate member extends from a corner joint with the outer plate member inward beyond the joint to the inner plate member to form an inwardly protruding guide rail portion. The outer plate member extends from the corner joint with the front plate member rearward beyond the joint to the rear plate member to form a rearwardly protruding guide rail portion. The tagline trolley is provided with rollers engaging the inwardly protruding guide rail portion and with roller engaging the rearwardly protruding guide rail portion.

### CROSS REFERENCE TO RELATED APPLICATIONS

This application is the National Phase of PCT International Application No. PCT/EP2023/078844, filed on Oct. 17, 2023, which claims priority under 35 U.S.C. 119(a) to Patent Application Nos. 2033359, filed in Netherlands on Oct. 19, 2022; and 2034632, filed in Netherlands on Apr. 19, 2023, all of which are hereby expressly incorporated by reference into the present application.

### FIELD OF THE INVENTION

The present invention relates to the field of cranes having a luffing crane boom that is provided with a tagline system.

### BACKGROUND OF THE INVENTION

Generally, the tagline system is provided to allow enhanced control of the motion, position, and/or orientation of the load during the hoisting process.

In particular in the field of installation and/or maintenance of wind turbines, e.g. offshore, the need exists for handling of components “at the height of the nacelle”, which includes, for example, the handling of the rotor blades during their installation to the hub of the wind turbine. Current designs propose or already have the nacelle at a height of more than 100 meters, e.g. at 120 meters or more, for example the Haliade-X 12 MW wind turbine.

Cranes with tagline systems are frequently employed to control the position and/or orientation of a wind turbine component, e.g. the rotor blade. This is, for example, not done only during the hoisting of the rotor blade but also, or just, during the mounting of the root end of the blade to the hub of the wind turbine.

Examples of cranes having a boom and provided with a tagline system are presented in EP1925582, EP2490975, EP2889251, and DE20201003269U.

In a commonly known design of cranes, the crane comprises:
a base structure, e.g. adapted to be mounted on a vessel, e.g. for fixation to the hull of the vessel;
a revolving structure slewable on a slew bearing about a vertical slew axis relative to the base structure, the structure being provided with a boom connection member,
a boom having a longitudinal axis, wherein the boom has an inner end connected to boom connection member, so that the boom is pivotal up and down about a boom pivot axis which is perpendicular to the longitudinal axis of a boom;
a luffing device for pivoting the boom up and down, comprising a luffing winch and a variable length luffing system,
a hoist assembly comprising a winch and a winch driven cable, which winch driven hoist cable passes over a sheave assembly on the boom to a load suspension device so as to hoist a load suspended from the hoist cable and the load suspension device, e.g. a wind turbine component,
wherein the boom comprises a boom leg, e.g. a single boom leg, embodied as a latticed hollow box structure, e.g. a rectangular cross section latticed hollow box structure, comprising a pair of front main chords at a front side of the boom leg, a pair of rear main chords at a rear side of the boom leg, the main chords being interconnected by lacing members between adjacent main chords.

### OBJECTS OF THE INVENTION

The present invention aims to integrate a tagline system in optimal manner into a crane boom, e.g. in view of stability of the tagline system and/or in view of production of the crane boom, and maintenance costs, etc.

### SUMMARY OF THE INVENTION

In the inventive crane at least one of the front main chords of the boom leg is formed from four steel planar plate members that are welded to one another in a rectangular or square cross-sectional arrangement, wherein the four plate members are:
a front plate member;
a rear plate member opposite the front plate member
an inner plate member,
an outer plate member opposite the inner plate member,
   wherein the front plate member extends from a corner joint with the outer plate member inward beyond a joint of the front plate member to the inner plate member, to form an inwardly protruding guide rail portion having an inner end face,
   wherein the outer plate member extends from the corner joint with the front plate member rearward beyond a joint of the outer plate member to the rear plate member to form a rearwardly protruding guide rail portion having a rear end face,
   wherein the tagline trolley is provided with a first roller set of one or more rollers engaging the inner end face of the inwardly protruding guide rail portion and with a second roller set of one or more roller engaging the rear end face of the rearwardly protruding guide rail portion.

This design of the main chord of the crane boom leg optimally integrates a rail assembly for a tagline trolley with the main chord.

The crane may have a single boom leg, but in other embodiments the crane may have two boom legs, for example in a A-frame arrangement or in a H-frame arrangement. In embodiments, each boom leg has one or more tagline trolleys thereon in the manner as described herein. So, possibly, one crane boom has four tagline trolleys.

In a practical embodiment, the tagline trolley is further provided with a third roller set of one or more rollers engaging a front face of the front plate member, perpendicular to the first roller set, and the tagline trolley is provided with a fourth roller set of one or more rollers engaging an outer face of the outer plate member, perpendicular to the second roller set.

For example, at least the front plate member and the outer plate member have a thickness of at least 15 millimeters, e.g. about 20-30 millimeters.

In an embodiment, each of the front main chords of the boom leg is formed from four steel planar plate members that are welded to one another in a rectangular or square cross-sectional arrangement, wherein the four plate members are:
a front plate member;
a rear plate member opposite the front plate member
an inner plate member,
an outer plate member opposite the inner plate member,
   wherein the front plate member extends from a corner joint with the outer plate member inward beyond a joint of the front plate member to the inner plate member, to form an inwardly protruding guide rail portion having an inner end face,
   wherein the outer plate member extends from the corner joint with the front plate member rearward beyond a joint of the outer plate member to the rear plate member to form a rearwardly protruding guide rail portion having a rear end face,
   wherein a respective tagline trolley is associated with a respective front main chord, each tagline trolley being provided with a first roller set of one or more rollers engaging the inner end face of the inwardly protruding guide rail portion of the respective front main chord and with a second roller set of one or more roller engaging the rear end face of the rearwardly protruding guide rail portion of the respective front main chord.

In a practical embodiment, each of the tagline trolleys is further provided with a third roller set of one or more rollers engaging a front face of the front plate member, perpendicular to the first roller set, and each tagline trolley is further provided with a fourth roller set of one or more rollers engaging an outer face of the outer plate member, perpendicular to the second roller set.

In an embodiment, the crane boom has over at least a section of its length two boom legs, each having two main chords at a front side of the boom leg, wherein at least one of said front chords is embodied according to the invention, possibly both front main chords.

When the boom legs are parallel to one another, as in a H-frame crane boom, the rail portions may extend to proximity of the tip of the boom over these chords. The boom can also have an A-frame boom design, wherein the two boom legs are angled to one another. Again, herein one or both main chords at the front side of each boom leg may be embodied according to the invention. In a lambda-design of the crane boom, wherein the boom continues at the apex of the two boom legs with a single distal boom section, e.g. as shown in WO2018/208158, main chords of the boom legs and/or of the distal boom section may be embodied according to the invention.

It is envisaged, for example, that one pair of taglines is used when performing a lift operation to control the load primarily in a horizontal plane, e.g. to control rotation of the load about a hoist cable from which the load is suspended. In embodiments, another pair of taglines is primarily used for control of the load in a vertical plane, e.g. to control orientation of the load about a horizontal axis. The provision of four tagline systems, each having its own rail assembly on a respective front main chord, allows to use the two pairs for control of the load in horizontal plane and vertical plane, respectively.

In embodiments, the tagline system further comprises a tagline trolley drive assembly for each tagline trolley, e.g. for each tagline trolley independently, which drive is assembly is configured to provide controlled displacement of the tagline trolley along the boom leg. For example, the tagline trolley drive assembly comprises a tagline trolley drive winch and associated cable to provide controlled displacement of the tagline trolley along the boom leg. In another embodiment, the tagline trolley drive is absent, and the trolley passively follows the motion of the load and/or load suspension device during hoisting.

In embodiments, the load suspension device is embodied as a blade lifting tool for installation of a rotor blade to a wind turbine. Various embodiments of such blade lifting tools are known in the art.

A second aspect of the invention relates to a crane, e.g. configured for use in the handling of one or more wind turbine components, e.g. for installation and/or maintenance of an offshore wind turbine, the crane comprising:
a base structure, e.g. adapted to be mounted on a vessel, e.g. for fixation to the hull of the vessel;
a revolving structure slewable on a slew bearing about a vertical slew axis relative to the base structure, the superstructure being provided with a boom connection member,
a boom having a longitudinal axis, wherein the boom has an inner end connected to boom connection member, so that the boom is pivotal up and down about a boom pivot axis which is perpendicular to the longitudinal axis of a boom;
a luffing device for pivoting the boom up and down, comprising a luffing winch and a variable length luffing system;
a hoist assembly comprising a winch and a winch driven cable, which winch driven hoist cable passes over a sheave assembly on the boom to a load suspension device so as to hoist a load suspended from the hoist cable and the load suspension device, e.g. a wind turbine component, e.g. a rotor blade,
a tagline system configured to control the load that is hoisted, which tagline system comprises:
   first and second tagline trolleys that are each movable along the boom in longitudinal direction of the boom,
   first and second tagline winches and respective first and second winch driven taglines,
      wherein the tagline system further comprises:
first and second tagline sheaves,
a transverse beam,
   wherein each tagline trolley has a chassis which is configured to releasably secure thereto, selectively, the respective tagline sheave or the transverse beam so that the transverse beam is supported by both the first and second tagline trolleys,
   and wherein the transverse beam provides spaced apart locations for the first and second taglines extending between the transverse beam and the load, in use of the crane and tagline system thereof.

The second aspect effectively allows for dual use of the tagline trolleys as they may either support a tagline sheave or the transverse beam when the use of such a transverse beam is preferred over the use of the tagline sheaves on the trolleys. Whether or not to use the transverse beam may depend on the situation, e.g. on the load to be handled, e.g. on the size of the rotor blade to be handled, and/or on the circumstances (e.g. wind load, etc.).

In practical embodiments, the transverse beam has a length that is greater than the crane boom, e.g. with the taglines being extended from axial ends of the transverse beam.

In an embodiment of the first and/or second aspect of the invention, the tagline trolleys are each provided with a sliding support for the transverse beam between the axial ends thereof allowing for variation of the spacing between the first and second trolleys as they are moved up and down the respective chord. For example, the main chords on which tagline trolleys travel may be non-parallel to one another, e.g. as illustrated in FIGS. 6 and 8.

A third aspect of the invention relates to a crane, e.g. configured for use in the handling of one or more wind turbine components, e.g. for installation and/or maintenance of an offshore wind turbine, the crane comprising:
a base structure, e.g. adapted to be mounted on a vessel, e.g. for fixation to the hull of the vessel;
a revolving structure slewable on a slew bearing about a vertical slew axis relative to the base structure, the superstructure being provided with a boom connection member,
a boom having a longitudinal axis, wherein the boom has an inner end connected to boom connection member, so that the boom is pivotal up and down about a boom pivot axis which is perpendicular to the longitudinal axis of a boom,
a luffing device for pivoting the boom up and down, comprising a luffing winch and a variable length luffing system,
a hoist assembly comprising a winch and a winch driven cable, which winch driven hoist cable passes over a sheave assembly on the boom to a load suspension device so as to hoist a load suspended from the hoist cable and the load suspension device, e.g. a wind turbine component, e.g. a rotor blade,
a tagline system configured to control the load that is hoisted, which tagline system comprises:
   first and second tagline trolleys that are each movable along the boom in longitudinal direction of the boom,
   first and second tagline winches and respective first and second winch driven taglines,
      wherein the tagline winches are mounted to the top portion of the crane boom.

This arrangement of the taglines winches may provide for enhance reeving of the taglines and/or enhanced operation of the tagline system.

The present invention also relates to a crane boom provided with a tagline system configured for mounting in a crane as described herein.

The present invention also relates to a vessel provided with a crane as described herein, e.g. wherein the load suspension device is embodied as a blade lifting tool for installation of a rotor blade to a wind turbine.

The present invention also relates to a method for installation of a rotor blade to a wind turbine, e.g. an offshore wind turbine, wherein use is made of a crane as described herein. The present invention will now be elucidated with reference to the drawings.

### BRIEF DESCRIPTION OF THE DRAWINGS

In the drawings:

FIG. 1 shows schematically a vessel equipped with a crane according to the invention,

FIG. 2 shows a portion of the crane boom of FIG. 1 provided with a tagline trolley,

FIG. 3 shows a close-up of the FIG. 2 with main front chord of the crane boom in cross-section and the tagline trolley travelling thereon,

FIG. 4 shows the close-up of FIG. 3 from a different angle,

FIG. 5 shows a portion of the crane boom of FIG. 1 provided with the tagline trolley from a different angle,

FIGS. 6a, 6b shows a part of a crane boom of a crane according to the invention during handling of a rotor blade of a wind turbine using a blade lifting tool,

FIG. 7 shows a tagline trolley of the crane of FIGS. 6a,6b,

FIG. 8 shows the crane of FIGS. 6a, 6b, wherein the taglines trolleys support a transverse beam of the tagline system

### DETAILED DESCRIPTION OF EMBODIMENTS

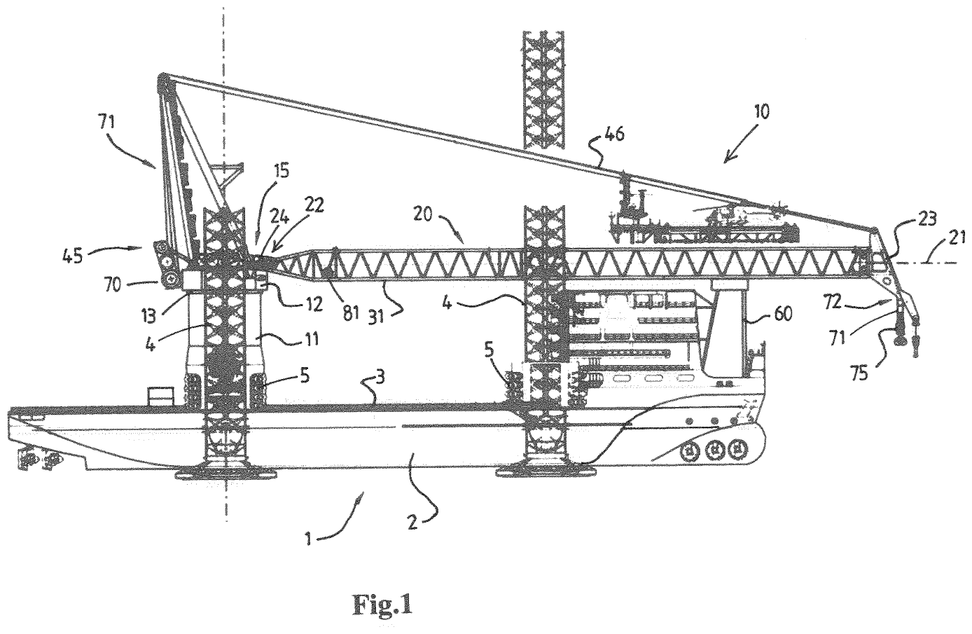

FIG. 1 schematically shows an offshore vessel 1 with hull 2, a deck 3, and a crane 10.

In this example, the vessel 1 is a jack-up vessel having jack-up legs 4 that can be extended and retracted by an associated jack-up mechanism 5. The vessel, in other embodiments, could also be of an entirely different design, e.g. a floating monohull vessel, a semi-submersible vessel, a catamaran-type vessel, etc.

It is noted that the inventive concept is equally applicable to land-based cranes having a latticed crane boom, e.g. for use in wind turbine installation. For example, the crane has a road-vehicle type wheeled base, a base with crawler tracks, a base with track engaging wheels, or a base that is assembled in situ where the wind turbine is to be assembled.

The crane 10, in this example, is embodied as a so-called around-the-leg crane 10. Here it is schematically illustrated that a leg extends through a pedestal 11 of the crane 10.

### The Pedestal 11 Is Mounted to, or Formed Integral With, the Hull 2 of the Vessel 1.

The crane 10 further comprises a revolving structure 12 which is supported on the pedestal 11 via slew bearing 13 for rotation of the structure 12 relative to the pedestal 11 about a vertical slew axis.

The revolving structure 12 comprises a boom connection member 15.

The crane 10 has a boom 20 with a longitudinal axis 21.

For example, the boom 20 has a length of at least 60 meters between an inner end 22 and a tip end 23 of the boom 20. The length may in practical embodiments exceed 100 meters, e.g. about 150 meters.

The inner end 22 is pivotally connected to the boom connection member 15 so that the boom 20 is pivotable up and down about a horizontal boom pivot axis 24 which is perpendicular to the longitudinal axis 21 of the boom.

It is shown here that the vessel is equipped with a boom rest 60, on which the boom 20 can rest in a horizontal rest position, for example as is shown in FIG. 1.

A luffing device for the boom 20 is provided for pivoting the boom 20 about the horizontal boom pivot axis 24. This luffing device comprising one or more boom luffing winches 45 and variable length luffing system with one or more luffing cables 46 driven by the one or more luffing winches 45.

The crane 10 has a hoist assembly with one or more main hoist winches 70 and one or more main hoist cables 71 driven by the one or more main hoist winches 70. Here the hoist winches 70 are shown on the revolving structure 12, but they could also be arranged elsewhere, e.g. on the crane boom 20, e.g. close to the inner end thereof.

Other arrangements of the one or more winches are also possible, e.g. when the crane 20 is embodied as a mast crane and the one or more hoist winches are located inside a pedestal of the crane, e.g. on a revolving platform as is known in the art.

The one or more cables 71 pass over a sheave assembly 72 near the tip of the boom 20 to a load suspension device 75, also referred to as main hoist block. For example, a so-called blade lifting tool can be suspended from the main hoist block 75 to handle a wind turbine rotor blade by means of the crane 10.

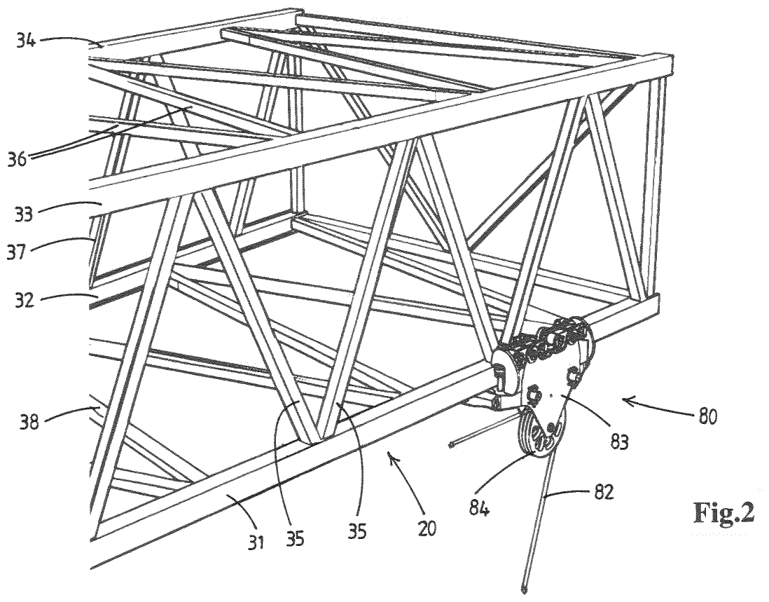

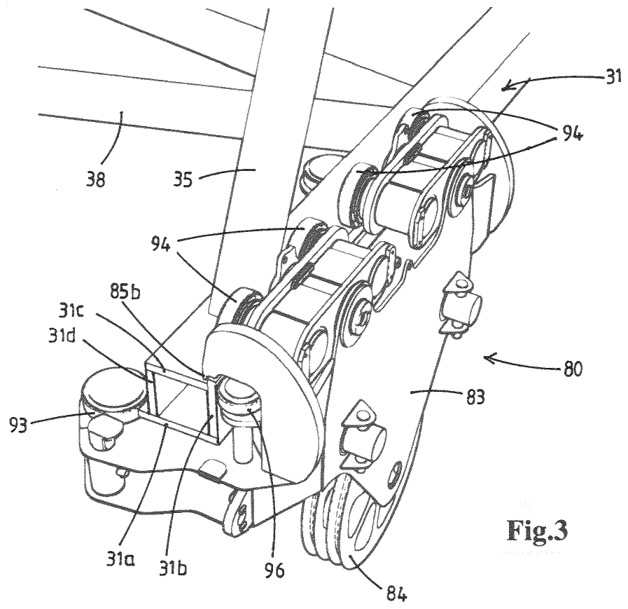

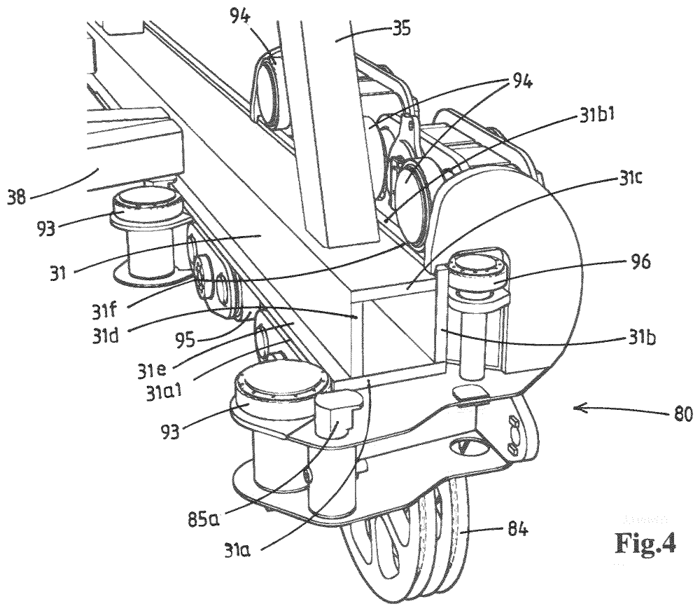

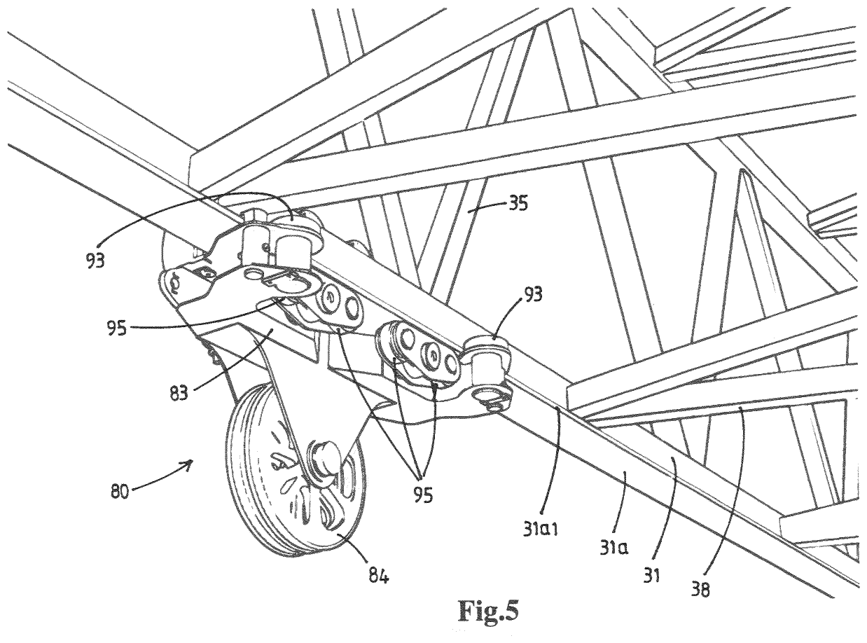

In the illustrated example, the boom 20 has a single boom leg that is embodied as a latticed hollow box structure, here a rectangular cross section latticed hollow box structure, e.g. as shown in FIGS. 2-5 . The latticed hollow box structure of the crane boom 20 is essentially a welded steel structure of rigid design.

The latticed hollow box structure comprises a pair of front main chords 31, 32, at a front side of the boom leg, a pair of rear main chords 33, 34 at a rear side of the boom leg, the main chords 31,32,33,34 being interconnected by lacing members 35, 36, 37, 38 between adjacent main chords. The lacing members 35, 36, 37, 38 generally define with the main chords 31,32, 33, 34 latticed hollow box. It is noted that other lacing members, e.g. within the hollow box, may also be present, e.g. as illustrated in FIG. 2 with one or more diagonal lacing members in a plane transverse to the boom length.

The crane 10 is provided with a tagline system configured to control motion of the load connector and/or the load, e.g. a wind turbine component, e.g. a rotor blade, that is hoisted. It is noted that the tagline system clearly may also be of use during lowering of the load connector and/or load, the term hoisting encompassing both hoisting and lowering.

The tagline system comprises a tagline trolley 80 that is movable along the boom leg in longitudinal direction of the boom leg. Furthermore a tagline winch 81 and a winch driven tagline 82 are present, which tagline—in use of the crane 10—extends from the tagline trolley 80 to the load and/or to the load suspension device 75.

Here, as an example, the tagline trolley 80 has a chassis 83 that is configured to be guided on and travel over a respective front main chord 31 with multiple roller sets of one or more rollers as will be explained in the example below.

The chassis 83 supports one or more tagline sheaves 84 over which the tagline 82 passes. The one or more sheaves 84 may be arranged to revolve about an axis that is of fixed orientation relative to the chassis 83, as shown, but pivotal arrangements of the one or more tagline sheaves 84 are also contemplated. For example, the one or more sheaves 84 being pivotal relative to the chassis 83 about an axis parallel to the front main chord.

In other designs of the tagline system in the context of the invention, the tagline is connected at an end thereof the trolley 80, e.g. with a tagline winch being provided on the load connector 75, and/or on a lifting tool, e.g. on a rotor blade lifting tool, and/or on the load. Of the tagline 82 passes from an end on the trolley to a sheave on the on the load connector 75, and/or on a lifting tool, e.g. on a rotor blade lifting tool, and/or on the load, and then back to a sheave on the trolley.

Preferably, the tagline system further comprises a tagline trolley drive assembly for each tagline trolley 80, e.g. for each tagline trolley on the crane boom 20 independently, which drive is assembly is configured to provide controlled displacement of the tagline trolley along the boom leg. For example, as known in the art, the tagline trolley drive assembly comprises a tagline trolley drive winch and associated cable to provide controlled displacement of the tagline trolley along the boom leg.

In the example, each of the front main chords 31, 32 of the boom leg is formed from four steel planar plate members that are welded to one another in a rectangular or square cross-sectional arrangement. This will be discussed herein with reference to front main chord 31, the other front main chord 32 being of the same design.

Herein, the term front refers to the side of the crane boom 20 where the hoisting is done by means of the hoist assembly, so where the load connector 75 and the suspended load are present during a hoist job for which the tagline system may provide enhanced control of the load connector and/or the load to be hoisted.

The four steel planar plate members that make up the hollow front main chord 31 are:
a front plate member 31a;
a rear plate member 31c opposite the front plate member,
an inner plate member 31d, and
an outer plate member 31b opposite the inner plate member.

These plate members are welded together to form the rectangular or square cross-sectional design of the front main chord 31.

The front plate member 31a extends from a welded corner joint with the outer plate member 31b inward beyond a welded joint of the front plate member 31a to the inner plate member 31d to form an inwardly protruding guide rail portion 31e having an inner end face 31a1.

The outer plate member 31b extends from the welded corner joint with the front plate member 31a rearward beyond a welded joint of the outer plate member 31b to the rear plate member 31c to form a rearwardly protruding guide rail portion 31f having a rear end face 31b1.

The tagline trolley 80 is provided with a first roller set 93 of one or more rollers, preferably multiple rollers, engaging the inner end face 31a1 of the inwardly protruding guide rail portion 31e.

The tagline trolley 80 is provided with second roller set 94 of one or more rollers, preferably multiple rollers, engaging the rear end face 31b1 of the rearwardly protruding guide rail portion 31f.

The tagline trolley is further provided with a third roller set 95 of one or more rollers, preferably multiple rollers, engaging a front face of the front plate member 31a, perpendicular to the first roller set 93,

The tagline trolley is provided with a fourth roller set 96 of one or more rollers, preferably multiple rollers, engaging an outer face of the outer plate member 31b, perpendicular to the second roller set 94.

As illustrated, it is preferred for the third roller set 95 and the fourth roller set 96 to engage on the front main chord 31 in proximity to the end face 31a1, 31b1 of the respective plate member.

The lacing members between the front main chords 31, 32 as well as between each front main chord 31, 32 and the nearest rear main chord 33, 34 are offset from the protruding portions of the front plate member and the outer plate member so as to allow for passage of the trolley, in particular for passage of the first and second roller sets 93, 94 of the trolley.

In an alternative embodiment, the second and/or third set(s) of rollers 95, 96 are absent. Instead, for example, the first and/or second set of rollers are equipped with grooved rollers that engage on the end face 31a1 or 31b1 to have guided support not only in the plane of the respective front plate member or outer plate member as shown here, but also perpendicular to the plane of the respective plate member. For example, the end face 31a1 or 31b1 can be beveled to have a V-shape, and the rollers having a corresponding shape.

The figures also illustrated the optional provision of one or more hook members 85a, b on the chassis 83 of the trolley 80, that engage behind the protruding section of the respective front plate member 31a or outer plate member 31b. These hook members 85a, 85b may serve to safeguard the mounting of the trolley 80 on the front main chord.

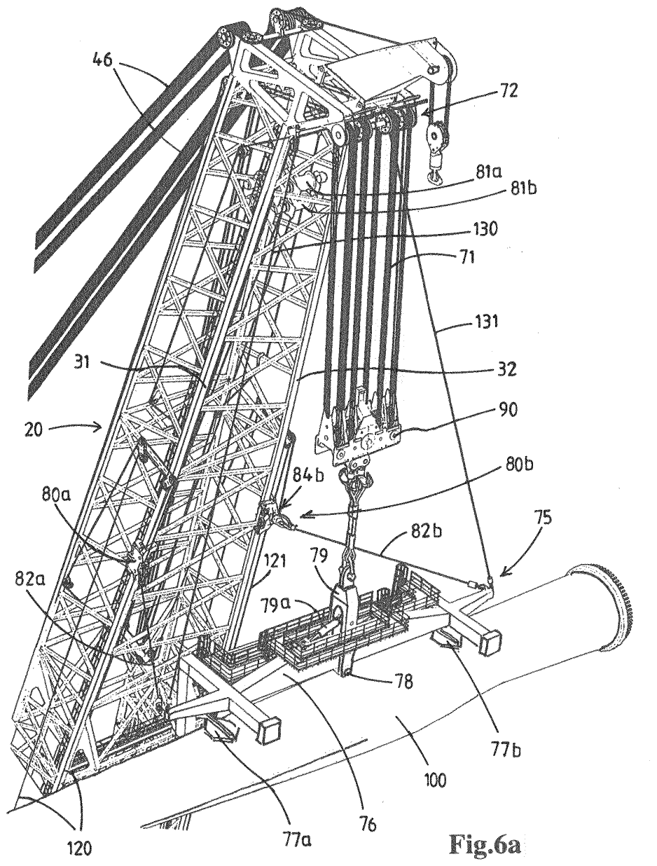

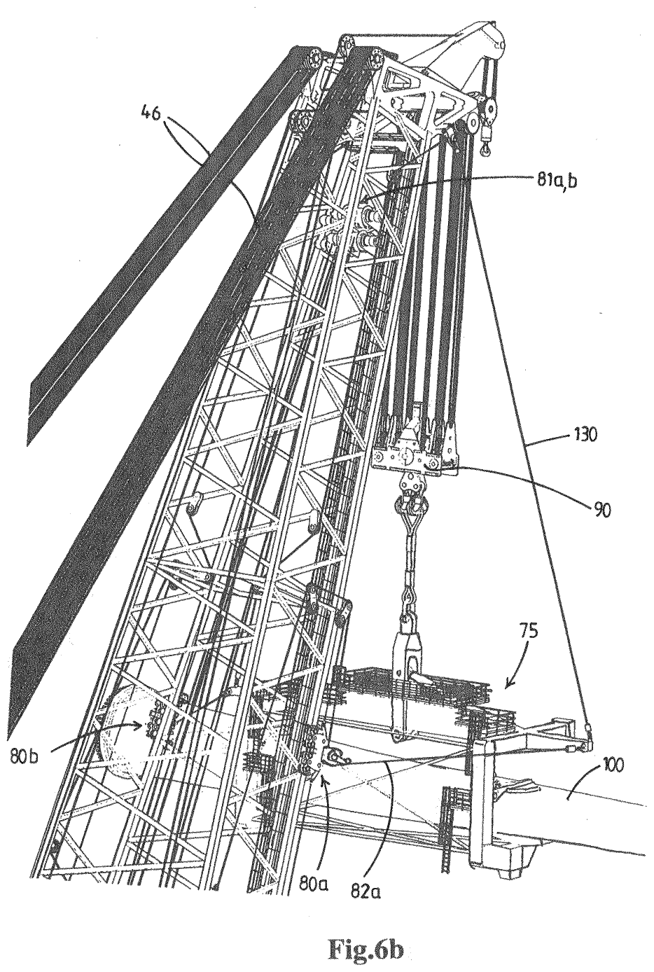

FIGS. 6a and 6b show a part of a crane according to the invention during handling of a rotor blade 100 of a wind turbine, e.g. an offshore wind turbine. Herein components discussed above with reference to FIGS. 1-5 are provided with the same reference numerals.

The rotor blade 100 of a wind turbine is held by a blade lifting tool 75 which is suspended below crane hook 90. The hook 90 and thereby the tool 75 is suspended from the crane boom tip of crane boom 20 via winch driven hoist cable 71 which passes over a sheave assembly 72.

The boom 20 has a section embodied as a latticed hollow box structure comprising a pair of front main chords 31, 32 at a front side of the boom, a pair of rear main chords 33, 34 at a rear side of the boom. The main chords 31, 32, 33, 34 are interconnected by lacing members between adjacent main chords.

A first tagline trolley 80a travels over the chord 31 and a second tagline trolley 80b travels over chord 32. Taglines 82a, b extend from the blade lifting tool 75 to a respective trolley 80a, b and from their via a reeving to tagline winches 81a, b. These tagline winches 81a, b are mounted in a top portion of the boom 20, but could also be mounted elsewhere, e.g. on the trolleys 80a, b. In another embodiment, tagline winches are present on the blade lifting tool 75, e.g. with a terminal end of the tagline being secured to a respective trolley 80a, b.

For controlled displacement of each tagline trolley 80a, b along the chord 31, 32 a respective tagline trolley drive assembly is provided. In the depicted example, cable 120 connects to trolley 80a and is driven by a winch, not shown, to move the trolley up and down. Cable 121 connects to trolley 80b and is driven by another winch, not shown, to move the trolley 80b up and down, preferably independent from trolley 80a.

The FIGS. 6a, 6b show that additional third and fourth taglines 130, 131 extend from the tip of the crane boom 20 down to the load suspension device 75, here the blade lifting tool. Each of these taglines 130, 131 is driven by an associated winch allowing for control of the device 75 and the load 100 primarily in the vertical plane, whereas the taglines 82a, b primarily act in the horizontal direction.

The FIGS. 6a, 6b show that the blade lifting tool 75 has a frame 76 with blade retention members, e.g. clamping members 77a, b. The frame 76 is tiltable connected via a horizontal axis hinge 78 to a pendant member 79 that is suspended from the crane hook 90. A tilt actuator 79a between the frame 76 and the pendant member 79 allows for controlled tilting of the tool 75 so as to set an inclination of the rotor blade 100, e.g. in view of installation of the blade 100 whilst inclined to the hub of the wind turbine.

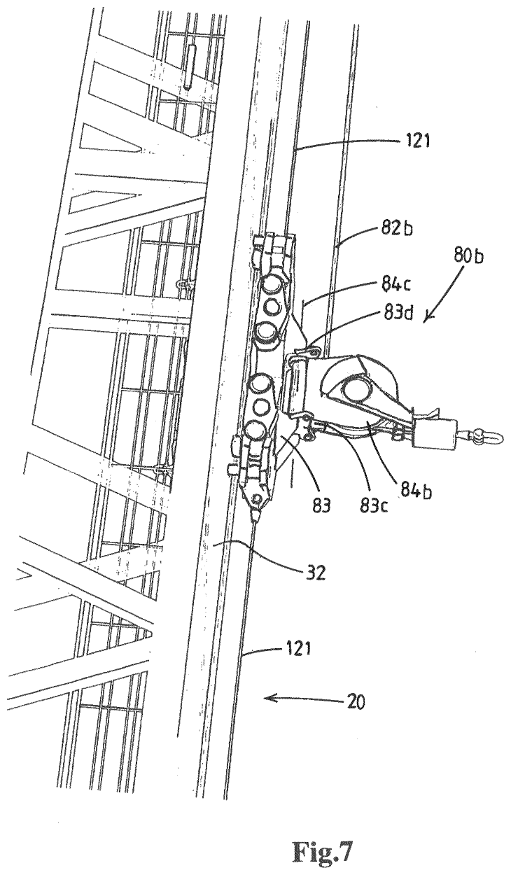

The FIG. 7 show a part of crane boom 20 of FIGS. 6a, 6b with second tagline trolley 80b travelling over main chord 32. The cable 121 allows to controllably move the trolley 80b up and down along the chord 32.

The FIG. 7 also shows that trolley 80b (as well as trolley 80a) has a chassis 83b that supports tagline sheave 84b in a pivotal manner about axis 84c parallel to the chord 32.

Each chassis 83 is configured to releasably secure the respective tagline sheave 84b to the chassis 83, so that the tagline sheave 84b can be removed.

Each chassis 83 is not only configured to support the respective tagline sheave 84b, but can also support a transverse beam 150 of the tagline system when the sheave 84 has been removed.

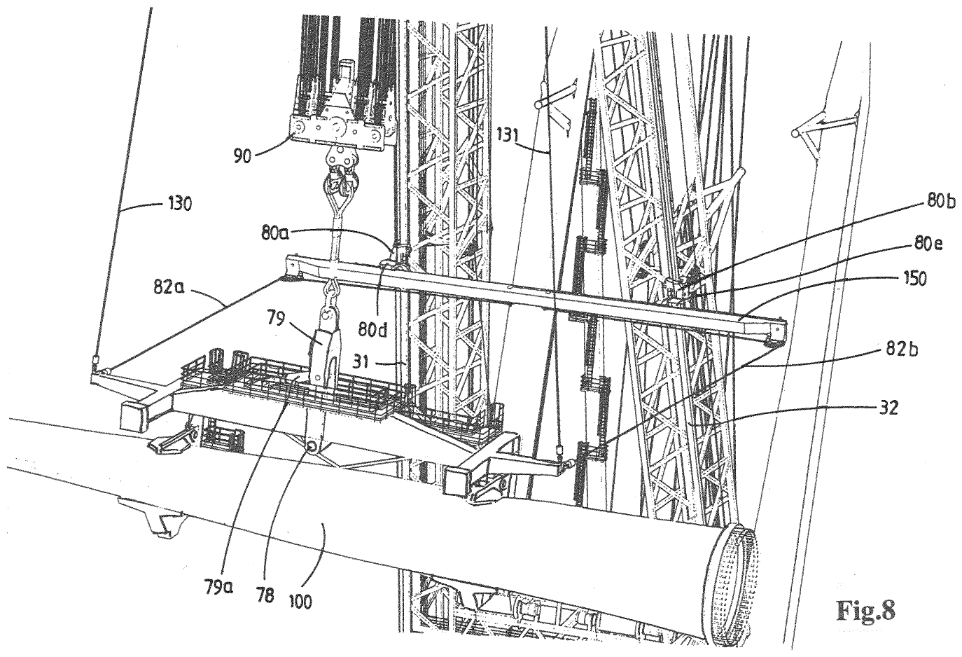

An example of a transverse beam 150 supported by the tagline trolleys 80a, b is depicted in FIG. 8.

The chassis 83 has one or more support flanges 83c, d to support the transverse beam 150. The FIG. 8 illustrates that transverse beam is supported by the first and second trolleys so as to extend in a direction transverse to the central plane of the crane boom 20. The transverse beam has axial ends.

The transverse beam 150 has a length that is greater than the crane boom, e.g. with the taglines 82a, b being extended towards the load from axial ends of the transverse beam.

In embodiments, the taglines 82a, 82b are extended crosswise when seen from above.

In this example, the beam 150 is of a fixed length, devoid of any telescoping section, the beam could be telescopic if desired, e.g. with telescopic beam end portions.

As the chords 31, 32 are non-parallel in the FIGS. 6-8 , it is envisaged that the trolleys 80a, 80b can, instead of the associated tagline sheave 84b, e.g. as an exchangeable part, be provided each with a sliding support 80d, 80e for the transverse beam 150 between the axial ends thereof allowing for variation of the spacing between the first and second trolleys 80a,b as they are moved up and down the respective chord 31, 32.

The tagline 82a extends from the blade lifting tool 75 to a tagline sheave 151 on the transverse beam 150, e.g. and further to a tagline winch 81a. The tagline 82b extends from the blade lifting tool 75 to a tagline sheave 152 on the transverse beam 150, e.g. and further to a tagline winch 81b.

The FIGS. 6-8 also serve to illustrate the second aspect of the invention relating to a crane, e.g. configured for use in the handling of one or more wind turbine components 100, e.g. for installation and/or maintenance of an offshore wind turbine, the crane comprising:
a base structure 11, e.g. adapted to be mounted on a vessel, e.g. for fixation to the hull of the vessel;
a revolving structure 12 slewable on a slew bearing about a vertical slew axis relative to the base structure, the superstructure being provided with a boom connection member,
a boom 20 having a longitudinal axis 21, wherein the boom has an inner end 22 connected to boom connection member, so that the boom is pivotal up and down about a boom pivot axis 24 which is perpendicular to the longitudinal axis of a boom;
a luffing device for pivoting the boom up and down, comprising a luffing winch 45 and a variable length luffing system 46;
a hoist assembly comprising a winch 70 and a winch driven cable 71, which winch driven hoist cable passes over a sheave assembly 72 on the boom to a load suspension device 75 so as to hoist a load suspended from the hoist cable and the load suspension device, e.g. a wind turbine component, e.g. a rotor blade 100,
a tagline system configured to control the load that is hoisted, which tagline system comprises:
   first and second tagline trolleys 80a, b that are each movable along the boom in longitudinal direction of the boom,
   first and second tagline winches 81a,b and respective first and second winch driven taglines 82a, bs,
      wherein the tagline system further comprises:
first and second tagline sheaves 84b, and
a transverse beam 150,
   wherein each tagline trolley 80a,b has a chassis 83b which is configured to releasably secure thereto, selectively, the respective tagline sheave 84a, b or the transverse beam 150 so that the transverse beam is supported by both the first and second tagline trolleys 80a, b,
   and wherein the transverse beam 150 provides spaced apart locations for the first and second taglines 82a, b extending between the transverse beam 150 and the load, here the tool 75, in use of the crane and tagline system thereof.

1-8. (canceled)

9. A crane comprising:
a base structure;
a revolving structure slewable on a slew bearing about a vertical slew axis relative to the base structure, the superstructure being provided with a boom connection member;
a boom having a longitudinal axis, wherein the boom has an inner end connected to boom connection member, so that the boom is pivotal up and down about a boom pivot axis which is perpendicular to the longitudinal axis of a boom;
a luffing device for pivoting the boom up and down, comprising a luffing winch and a variable length luffing system; and
a hoist assembly comprising a winch and a winch driven cable, which winch driven hoist cable passes over a sheave assembly on the boom to a load suspension device so as to hoist a load suspended from the hoist cable and the load suspension device,
wherein the boom comprises a boom leg embodied as a latticed hollow box structure comprising a pair of front main chords at a front side of the boom leg, a pair of rear main chords at a rear side of the boom leg, the main chords being interconnected by lacing members between adjacent main chords,
wherein the crane further comprising:
a tagline system configured to control the load that is hoisted, which tagline system comprises:
a tagline trolley that is movable along the boom leg in longitudinal direction of the boom leg; and
a tagline winch and a winch driven tagline which tagline, in use of the crane, extends from the tagline trolley to the load and/or to the load suspension device;
wherein at least one of the front main chords of the boom leg is formed from four steel planar plate members that are welded to one another in a rectangular or square cross-sectional arrangement,
wherein the four plate members include:
a front plate member;
a rear plate member opposite the front plate member;
an inner plate member; and
an outer plate member opposite the inner plate member,
wherein the front plate member extends from a corner joint with the outer plate member inward beyond a joint of the front plate member to the inner plate member to form an inwardly protruding guide rail portion having an inner end face,
wherein the outer plate member extends from the corner joint with the front plate member rearward beyond a joint of the outer plate member to the rear plate member to form a rearwardly protruding guide rail portion having a rear end face, and
wherein the tagline trolley is provided with a first roller set of one or more rollers engaging the inner end face of the inwardly protruding guide rail portion and with a second roller set of one or more rollers engaging the rear end face of the rearwardly protruding guide rail portion.

10. The crane according to claim 9, wherein the tagline trolley further includes a third roller set of one or more rollers engaging a front face of the front plate member, perpendicular to the first roller set, and
wherein the tagline trolley is provided with a fourth roller set of one or more rollers engaging an outer face of the outer plate member, perpendicular to the second roller set.

11. The crane according to claim 9, wherein each of the front main chords of the boom leg is formed from four steel planar plate members that are welded to one another in a rectangular or square cross-sectional arrangement, wherein the four plate members include:
a front plate member;
a rear plate member opposite the front plate member;
an inner plate member; and
an outer plate member opposite the inner plate member,
wherein the front plate member extends from a corner joint with the outer plate member inward beyond a joint of the front plate member to the inner plate member, to form an inwardly protruding guide rail portion having an inner end face,
wherein the outer plate member extends from the corner joint with the front plate member rearward beyond a joint of the outer plate member to the rear plate member to form a rearwardly protruding guide rail portion having a rear end face, and
wherein a respective tagline trolley is associated with a respective front main chord, each tagline trolley being provided with a first roller set of one or more rollers engaging the inner end face of the inwardly protruding guide rail portion of the respective front main chord and with a second roller set of one or more roller engaging the rear end face of the rearwardly protruding guide rail portion of the respective front main chord.

12. The crane according to claim 9, wherein the tagline system further comprises a tagline trolley drive assembly for each tagline trolley, which drive is assembly is configured to provide controlled displacement of the tagline trolley along the boom leg.

13. The crane according to claim 12, wherein the tagline trolley drive assembly comprises a tagline trolley drive winch and associated cable to provide controlled displacement of the tagline trolley along the boom leg.

14. The crane according to claim 9, wherein the load suspension device includes a blade lifting tool for installation of a rotor blade to a wind turbine.

15. A crane boom provided with a tagline system configured for mounting in a crane,
the boom having a longitudinal axis, wherein the boom has an inner end configured to be connected to a boom connection member, so that the boom is pivotal up and down about a boom pivot axis which is perpendicular to the longitudinal axis of a boom,
wherein the boom comprises a boom leg embodied as a latticed hollow box structure, comprising a pair of front main chords at a front side of the boom leg, a pair of rear main chords at a rear side of the boom leg, the main chords being interconnected by lacing members between adjacent main chords,
wherein the tagline system being configured to control motion of a load that is hoisted, which tagline system comprises:
a tagline trolley that is movable along the boom leg in longitudinal direction of the boom leg; and
a tagline winch and a winch driven tagline, which tagline, in use of the crane, extends from the tagline trolley to the load and/or to a load suspension device,
wherein at least one of the front main chords of the boom leg is formed from four steel planar plate members that are welded to one another in a rectangular or square cross-sectional arrangement, wherein the four plate members include:
a front plate member;
a rear plate member opposite the front plate member;
an inner plate member; and
an outer plate member opposite the inner plate member,
wherein the front plate member extends from a corner joint with the outer plate member inward beyond a joint of the front plate member to the inner plate member to form an inwardly protruding guide rail portion having an inner end face,
wherein the outer plate member extends from the corner joint with the front plate member rearward beyond a joint of the outer plate member to the rear plate member to form a rearwardly protruding guide rail portion having a rear end face, and
wherein the tagline trolley is provided with a first roller set of one or more rollers engaging the inner end face of the inwardly protruding guide rail portion and with a second roller set of one or more rollers engaging the rear end face of the rearwardly protruding guide rail portion.

16. A vessel provided with a crane according to claim 9.
